(19) United States
(12) Patent Application Publication
(10) Pub. No.: US 2010/0321298 A1
(43) Pub. Date: Dec. 23, 2010

(54) KEYBOARD AND TOUCHPAD COMBINATION

(75) Inventors: HUO-LU TSAI, Ta Ya Shiang (TW); Yung-Lung Liu, Ta Ya Shiang (TW)

Correspondence Address: G. LINK CO., LTD., 3550 BELL ROAD, MINOKA, IL, 60447, US

(73) Assignee: Sunrex Technology Corp., Ta Ya Shiang (TW)

(21) Appl. No.: 12/486,412

(22) Filed: Jun. 17, 2009

(51) Int. Cl. G06F 3/02

(52) U.S. Cl. 345/168; 345/173

(57) ABSTRACT

A keyboard and touchpad combination for a computer in one embodiment includes a hollow frame; a touchpad fitted in frame; a character membrane comprising printed characters; a rubber keyboard comprising raised top keys and guide stems each extending downward from the key; a brace board for positioning the rubber keyboard and comprising holes for loosely receiving the keys; a membrane circuit board comprising dome switches each corresponding to the guide stem thereabove, each dome switch including a conductive contact on a top of its inner surface, and pairs of conductive lines, each pair of the conductive lines being directly below the conductive contact; and a bottom plate. The keyboard and touchpad combination can be operated as a keyboard or a touchpad.

### BACKGROUND OF THE INVENTION

1. Field of Invention

The invention relates to computer input devices and more particularly to such a computer input device having a touchpad mounted on a keyboard with improved characteristics.

2. Description of Related Art

Conventionally, a notebook computer has a touchpad as an input device in addition to a keyboard. The touchpad is provided to the right of the keyboard or below the keyboard. In use a relative motion of a finger on the touchpad surface may cause a relative motion of a cursor on the computer screen.

However, the well known notebook computer keyboard suffers from a couple of disadvantages. For example, the use of touchpad is not convenient because the conventional touchpad is small. Further, the touchpad may occupy a portion of the precious area of the keyboard surface since the touchpad is not provided on top of the keyboard. Both are not desirable. Thus, a need for improvement exists.

### SUMMARY OF THE INVENTION

It is therefore one object of the invention to provide a keyboard and touchpad combination without the disadvantages of inconvenient touchpad use and the touchpad occupying a portion of the precious area of the keyboard surface.

To achieve the above and other objects, the invention provides a keyboard and touchpad combination for a computer comprising a frame having a rectangular hollow; a touchpad made of transparent plastic and shaped to fit snugly in the hollow, the touchpad comprising a circuitry and being a capacitive touchpad; a rectangular character membrane comprising a plurality of characters printed thereon; a rectangular rubber keyboard formed by injection molding a rubber material, the rubber keyboard being adhered to a bottom of the character membrane and comprising a plurality of raised keys on a top surface, and a plurality of guide stems each extending from a bottom of the key wherein the character membrane is disposed on the rubber keyboard and the touchpad is disposed on the character membrane; a brace board made of hard plastic for positioning the rubber keyboard and comprising a plurality of spaced holes for receiving the keys so that each of the guide stems is adapted to elastically travel to and forth along the hole, and a plurality of support posts; a membrane circuit board with the support post disposed thereon, the membrane circuit board comprising a circuitry electrically connected to the circuitry of the touchpad, a plurality of dome switches each corresponding to the guide stem thereabove, each of the dome switches including a conductive contact on a top of its inner surface, and a plurality of pairs of conductive lines, each pair of conductive lines being directly below the conductive contact; and a bottom plate for supporting the frame, the touchpad, the character membrane, the rubber keyboard, the brace board, and the membrane circuit board, whereby pressing the touchpad above one of the keys will depress corresponding portions of the touchpad, the character membrane, and the rubber keyboard, cause the guide stem of the key to travel downward to depress and elastically deform the dome switch therebelow, and connect the conductive contact of the dome switch to the conductive lines so that a scanning signal representing the depressed key is generated by the membrane circuit board, the scanning signal is sent to the computer for processing, and a character corresponding to the depressed key is displayed on a screen of the computer; or whereby moving a finger on the touchpad will generate an electric signal representing a relative motion of the finger on the touchpad, send the electric signal from the touchpad to the computer via the membrane circuit board for processing, and a relative motion of a cursor is shown on the screen of the computer.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of keyboard and touchpad combination according to the invention;

FIG. 2 is a perspective view of the assembled keyboard and touchpad combination;

FIG. 3 is a sectional view of FIG. 2 with both bottom plate and frame removed for illustrating a key press operation;

FIG. 4 is a view similar to FIG. 3 illustrating a relative motion of a finger on the touchpad surface;

FIG. 5 is an exploded view of a second preferred embodiment of keyboard and touchpad combination according to the invention; and

FIG. 6 is a sectional view of the assembled keyboard and touchpad combination in FIG. 5 with both bottom plate and frame removed for illustrating a key press operation.

### DETAILED DESCRIPTION OF THE INVENTION

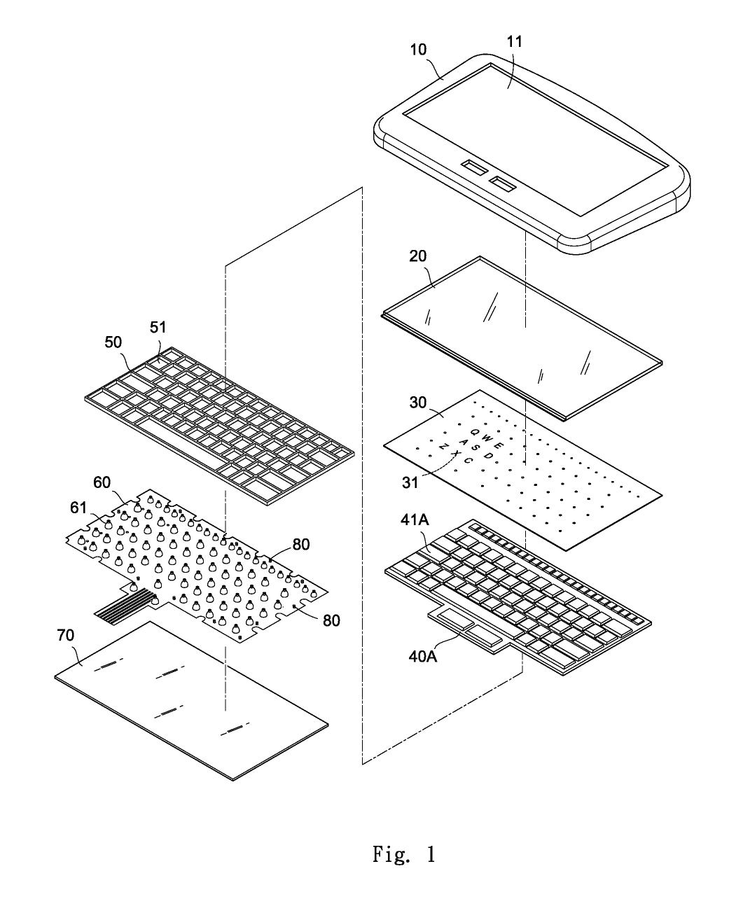

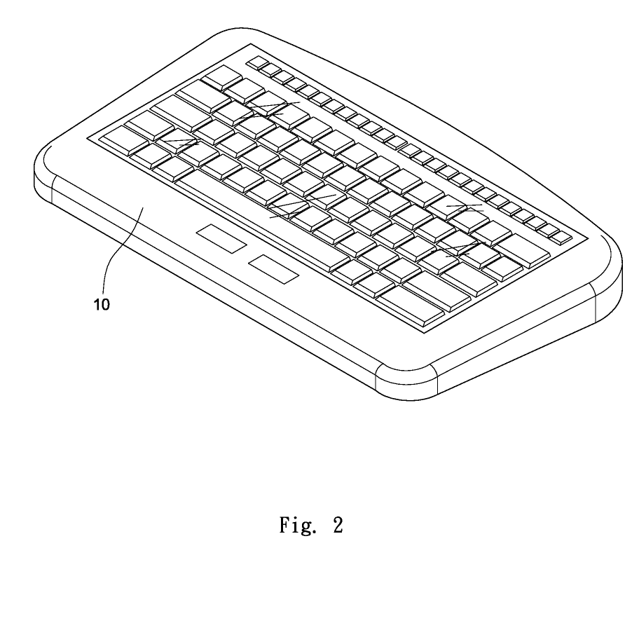

Referring to FIGS. 1 to 4, a keyboard and touchpad combination in accordance with a first preferred embodiment of the invention comprises the following components as discussed in detail below.

A frame 10 is of rectangular and is made of hard plastic. The frame 10 has a rectangular hollow 11 defined therein.

A touchpad 20 is made of transparent plastic. The touchpad 20 is of rectangular and is dimensioned and shaped to fit snugly in the hollow 11. The touchpad 20 comprises circuitry (not shown). The touchpad 20 is a capacitive touchpad in this embodiment.

A rectangular character membrane 30 has a plurality of characters 31 formed thereon by printing. The character membrane 30 is also dimensioned and shaped to fit snugly under the touchpad 20.

A rubber keyboard 40A is integrally formed by injection molding a rubber material. The rubber keyboard 40A is adhered to a bottom of the character membrane 30. The rubber keyboard 40A comprises a plurality of raised keys 41A on its top surface. It is shown that the character membrane 30 is provided on the rubber keyboard 40A and the touchpad 20 is in turn provided on the character membrane 30 in a stacked fashion. A plurality of guide stems 42A each is extended from a bottom of the key 41A.

A brace board 50 is of rectangular for supporting the rubber keyboard 40A. The brace board 50 is made of hard plastic and comprises a plurality of spaced holes 51 for receiving the keys 41A so that the rubber keyboard 40A can be positioned. The guide stem 42A is adapted to elastically travel to and forth along the hole 51 in a key press operation as detailed later. The brace board 50 further comprises a plurality of support posts 52 for supporting the touchpad 20, the character membrane 30, and the rubber keyboard 40A.

A membrane circuit board 60 is of rectangular and is dimensioned and shaped to fit snugly under the brace board 50. The membrane circuit board 60 comprises circuitry (not shown) electrically connected to the circuitry of the touchpad 20. The membrane circuit board 60 further comprises a plurality of dome switches 61 corresponding to the guide stems 42A thereabove. Each dome switch 61 comprises a conductive contact 62 on a top of its inner surface. Below the conductive contact 62 there are provided a pair of conductive lines (not numbered) on the membrane circuit board 60. The dome switches 61 are made of rubber or resilient metal pieces.

A bottom plate 70 is a hard rectangular plate and is provided to support the frame 10, the touchpad 20, the character membrane 30, the rubber keyboard 40A, the brace board 50, and the membrane circuit board 60.

Additionally, a plurality of LEDs (light-emitting diodes) 80 are provided on the membrane circuit board 60 and are electrically connected thereto if the invention is envisaged to operate in a dark environment. Further, both the rubber keyboard 40A and the character membrane 30 are made of transparent plastic material in order to achieve the above purpose.

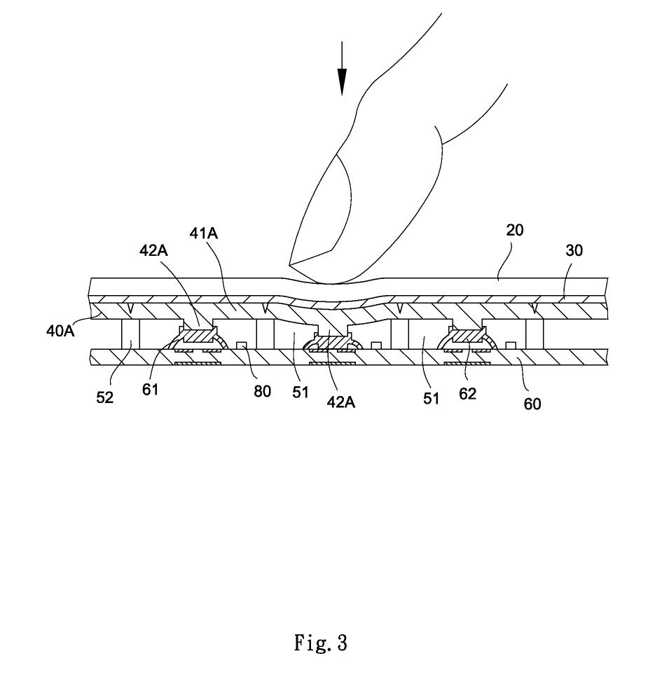

Referring to FIG. 3 specifically, a user may press a portion of the touchpad 20 surface above a desired key 41A. And in turn, corresponding portions of the touchpad 20, the character membrane 30, and the rubber keyboard 40A are depressed. The guide stem 42A then travels downward a short distance to depress the dome switch 61. The dome switch 61 is elastically deformed to cause its conductive contact 62 to touch (and hence connects) the conductive lines on the membrane circuit board 60. This bridges a gap between the conductive lines and allows electric current to flow (i.e., the circuit is closed). A scanning signal representing a “make code” of the depressed key 41A is generated by the membrane circuit board 60. The scanning signal is then sent to the CPU (central processing unit) of the computer for processing. Finally, a character corresponding to the depressed key 41A is displayed on the computer screen.

It is contemplated by the invention that thin touchpad 20 and rubber keyboard 40A can carry out the key press operation.

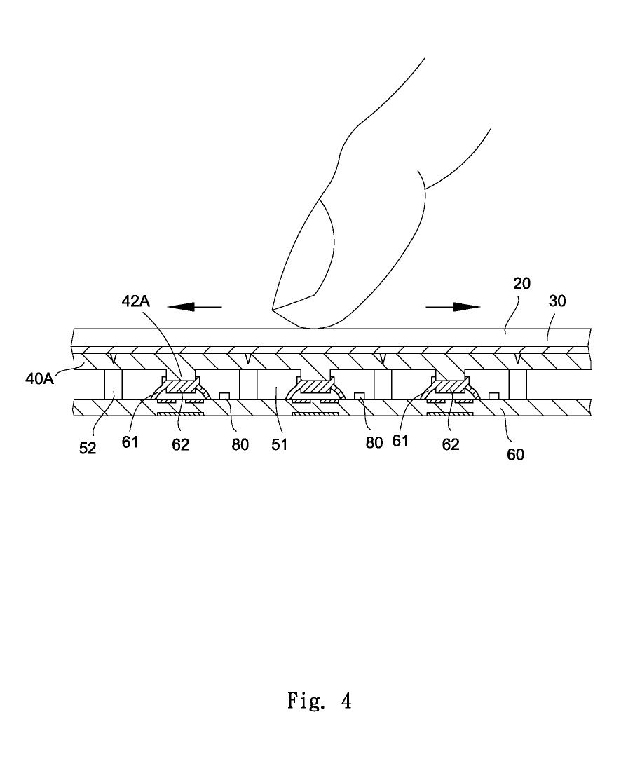

Referring to FIG. 4 specifically, a user may move the finger on the touchpad 20 surface (i.e., relative motion of the finger on the touchpad 20 surface). As a result, an electric signal representing a relative motion of the finger on the touchpad 20 surface is generated by the touchpad 20. The electric signal is then sent from the touchpad 20 to the membrane circuit board 60. The membrane circuit board 60 sends same to the CPU of the computer for processing. Finally, a relative motion of a cursor is shown on the computer screen.

It is contemplated by the invention that the touchpad 20 is mounted above the rubber keyboard 40A so that a thin computer keyboard is effected. Also, area of the touchpad 20 is maximized so as to facilitate the operations of both the touchpad 20 and the rubber keyboard 40A. As a result, the conventional disadvantages including inconvenient touchpad use and the touchpad occupying a portion of the precious area of the keyboard surface are eliminated.

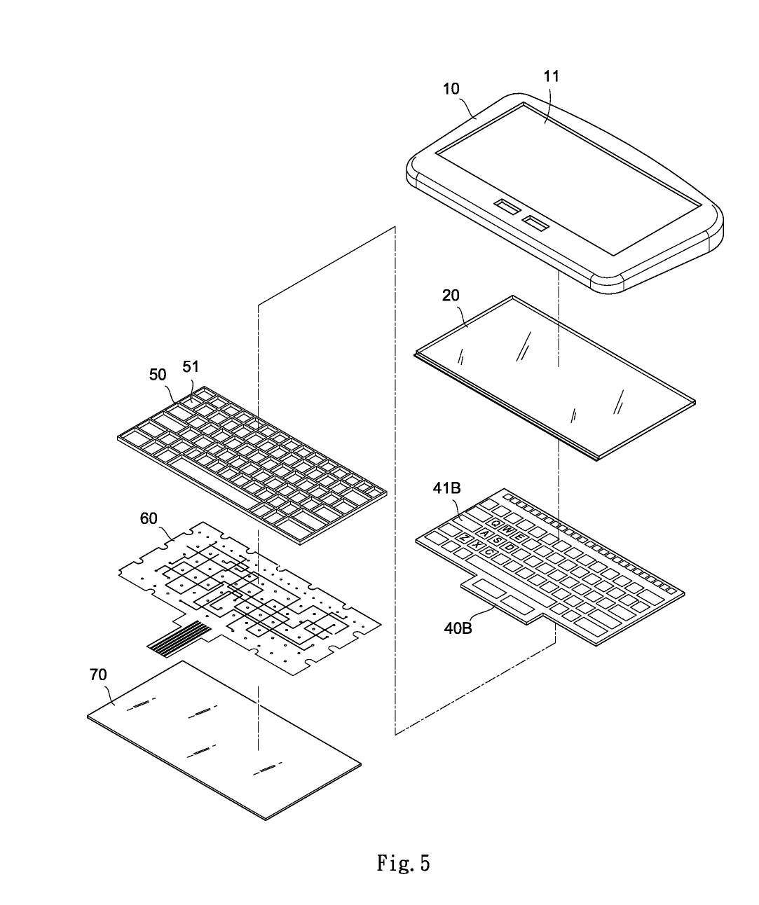

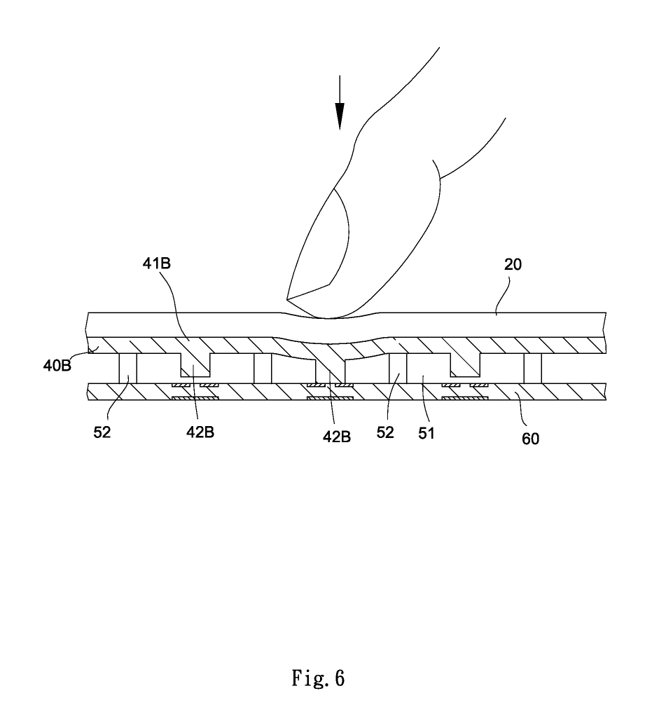

Referring to FIGS. 5 and 6, a keyboard and touchpad combination in accordance with a second preferred embodiment of the invention is shown. The characteristics of the second preferred embodiment are detailed below. The character membrane is eliminated. A plurality of flat keys 41B are formed on a top surface of a rubber keyboard 40B. Top of each key 41B is printed with a unique character. That is, the character membrane and the rubber keyboard 40B are formed integrally by injection molding. Further, the rubber keyboard 40B and the brace board 50 may be formed integrally by injection molding in other embodiments. A plurality of guide stems 42B each is extended from a bottom of the key 41B. Each guide stem 42B comprises a conductive contact (not numbered) on a bottom. Below the conductive contact there are provided a pair of conductive lines (not numbered) on the membrane circuit board 60. The dome switches 61 are eliminated so that a simplified membrane circuit board 60 is obtained. Hence, the second preferred embodiment has a reduced number of components.

Referring to FIG. 6 specifically, a user may press a portion of the touchpad 20 surface above a desired key 41B. And in turn, corresponding portions of both the touchpad 20 and the rubber keyboard 40B are depressed. The guide stem 42B then travels downward a short distance to cause its conductive contact to touch (and hence connects) the conductive lines on the membrane circuit board 60. This bridges a gap between the conductive lines and allows electric current to flow (i.e., the circuit is closed). A scanning signal representing a “make code” of the depressed key 41B is generated by the membrane circuit board 60. The scanning signal is then sent to the CPU of the computer for processing. Finally, a character corresponding to the depressed key 41B is displayed on the computer screen.

It is contemplated by the invention that a large touchpad 20 is provided above the rubber keyboard 40A or on the rubber keyboard 40B. Hence, a large operation area of the touchpad 20 is obtained and it is substantially equal to the surface area of either the rubber keyboard 40A or the rubber keyboard 40B. In brief, a touchpad surface of the invention can be employed as a typical touchpad or a typical keyboard.

While the invention herein disclosed has been described by means of specific embodiments, numerous modifications and variations could be made thereto by those skilled in the art without departing from the scope and spirit of the invention set forth in the claims.

What is claimed is:

1. A keyboard and touchpad combination for a computer comprising:
a frame having a rectangular hollow;
a touchpad made of transparent plastic and shaped to fit snugly in the hollow, the touchpad comprising a circuitry and being a capacitive touchpad;
a rectangular character membrane comprising a plurality of characters printed thereon;
a rectangular rubber keyboard formed by injection molding a rubber material, the rubber keyboard being adhered to a bottom of the character membrane and comprising a plurality of raised keys on a top surface, and a plurality of guide stems each extending from a bottom of the key wherein the character membrane is disposed on the rubber keyboard and the touchpad is disposed on the character membrane;
a brace board made of hard plastic for positioning the rubber keyboard and comprising a plurality of spaced holes for receiving the keys so that each of the guide stems is adapted to elastically travel to and forth along the hole, and a plurality of support posts;
a membrane circuit board with the support posts disposed thereon, the membrane circuit board comprising a circuitry electrically connected to the circuitry of the touchpad, a plurality of dome switches each corresponding to the guide stem thereabove, each of the dome switches including a conductive contact on a top of its inner surface, and a plurality of pairs of conductive lines, each pair of the conductive lines being directly below the conductive contact; and
a bottom plate for supporting the frame, the touchpad, the character membrane, the rubber keyboard, the brace board, and the membrane circuit board,
whereby pressing the touchpad above one of the keys will depress corresponding portions of the touchpad, the character membrane, and the rubber keyboard, cause the guide stem of the key to travel downward to depress and elastically deform the dome switch therebelow, and connect the conductive contact of the dome switch to the conductive lines so that a scanning signal representing the depressed key is generated by the membrane circuit board, the scanning signal is sent to the computer for processing, and a character corresponding to the depressed key is displayed on a screen of the computer; or
whereby moving a finger on the touchpad will generate an electric signal representing a relative motion of the finger on the touchpad, send the electric signal from the touchpad to the computer via the membrane circuit board for processing, and a relative motion of a cursor is shown on the screen of the computer.

2. The keyboard and touchpad combination of claim 1, further comprising a plurality of LEDs (light-emitting diodes) disposed on the membrane circuit board and electrically connected thereto, and wherein both the rubber keyboard and the character membrane are made of transparent plastic material.

3. A keyboard and touchpad combination for a computer comprising:
a frame having a rectangular hollow;
a touchpad made of transparent plastic and shaped to fit snugly in the hollow, the touchpad comprising a circuitry and being a capacitive touchpad;
a rectangular rubber keyboard formed by injection molding a rubber material, the rubber keyboard comprising a plurality of flat keys on a top surface, each of the keys having a character printed thereon, and a plurality of guide stems each extending from a bottom of the key, each of the guide stems having a conductive contact on a bottom wherein the touchpad is disposed on the rubber keyboard;
a brace board integrally formed with the rubber keyboard for positioning the rubber keyboard and comprising a plurality of spaced holes for receiving the keys so that each of the guide stems is adapted to elastically travel to and forth along the hole, and a plurality of support posts;
a membrane circuit board with the support posts disposed thereon and comprising a circuitry electrically connected to the circuitry of the touchpad, and a plurality of pairs of conductive lines, each pair of the conductive lines being directly below the conductive contact; and
a bottom plate for supporting the frame, the touchpad, the rubber keyboard, the brace board, and the membrane circuit board,
whereby pressing the touchpad above one of the keys will depress corresponding portions of the touchpad and the rubber keyboard, cause the guide stem of the key to travel downward to connect the conductive contact of the guide stem to the conductive lines so that a scanning signal representing the depressed key is generated by the membrane circuit board, the scanning signal is sent to the computer for processing, and a character corresponding to the depressed key is displayed on a screen of the computer; or
whereby moving a finger on the touchpad will generate an electric signal representing a relative motion of the finger on the touchpad, send the electric signal from the touchpad to the computer via the membrane circuit board for processing, and a relative motion of a cursor is shown on the screen of the computer.

4. The keyboard and touchpad combination of claim 3, further comprising a plurality of LEDs (light-emitting diodes) disposed on the membrane circuit board and electrically connected thereto, and wherein the rubber keyboard is made of transparent plastic material.

5. A keyboard and touchpad combination for a computer comprising:
a frame having a rectangular hollow;
a touchpad made of transparent plastic and shaped to fit snugly in the hollow, the touchpad comprising a circuitry and being a capacitive touchpad;
a rectangular rubber keyboard formed by injection molding a rubber material, the rubber keyboard comprising a plurality of flat keys on a top surface, each of the keys having a character printed thereon, and a plurality of guide stems each extending from a bottom of the key, each of the guide stems having a conductive contact on a bottom wherein the touchpad is disposed on the rubber keyboard;
a brace board made of hard plastic for positioning the rubber keyboard and comprising a plurality of spaced holes for receiving the keys so that each of the guide stems is adapted to elastically travel to and forth along the hole, and a plurality of support posts;
a membrane circuit board with the support posts disposed thereon, the membrane circuit board comprising a circuitry electrically connected to the circuitry of the touchpad, and a plurality of pairs of conductive lines, each pair of the conductive lines being directly below the conductive contact; and
a bottom plate for supporting the frame, the touchpad, the rubber keyboard, the brace board, and the membrane circuit board,
whereby pressing the touchpad above one of the keys will depress corresponding portions of the touchpad and the rubber keyboard, cause the guide stem of the key to travel downward to connect the conductive contact of the guide stem to the conductive lines so that a scanning signal representing the depressed key is generated by the membrane circuit board, the scanning signal is sent to the computer for processing, and a character corresponding to the depressed key is displayed on a screen of the computer; or
whereby moving a finger on the touchpad will generate an electric signal representing a relative motion of the finger on the touchpad, send the electric signal from the touchpad to the computer via the membrane circuit board for processing, and a relative motion of a cursor is shown on the screen of the computer.

6. The keyboard and touchpad combination of claim 5, further comprising a plurality of LEDs (light-emitting diodes) disposed on the membrane circuit board and electrically connected thereto, and wherein the rubber keyboard is made of transparent plastic material.
